(19) United States
(12) Patent Application Publication
(10) Pub. No.: US 2002/0101083 A1
(43) Pub. Date: Aug. 1, 2002

(54) Mortise lock with automatic dead bolt

(75) Inventors: Albert Toledano, Montreal (CA); Christian Doucet, St. Bruno (CA)

Correspondence Address: David M. Carter, CARTER & SCHNEDLER, P.O. Box 2985, 56 Central Avenue, Suite 101, Asheville, NC, 28802, US

(73) Assignee: Ilco Unican Inc.

(21) Appl. No.: 09/775,363

(22) Filed: Feb. 1, 2001

(51) Int. Cl. E05B 63/20

(52) U.S. Cl. 292/332; 292/63

(57) ABSTRACT

A mortise lock for mounting in a door opposite a strike plate secured in a door jamb. A turn piece is connected to a thumb turn which is rotatable to a predetermined first or predetermined second position for an electronic or a magnetic recognition. The thumb turn manually locks the deadbolt in a dead bolt armed retracted position. A trigger bolt mechanism is provided for operative contact with a latch bolt arresting mechanism.

### FIELD OF THE INVENTION

The present invention relates generally to a door-mounted mortise lock that includes a dead bolt that is automatically actuated to an extended and locked position when the door is closed, and more importantly, but not exclusively, to improvements to the locking and releasing mechanisms.

### BACKGROUND OF THE INVENTION

Mortise locks employing automatic dead bolts are often used in hotel room doors. The automatic release of the dead bolt is actuated by a trigger bolt when the door is closed, thereby saving the user from manually throwing the dead bolt. It further ensures that the closed door is always secured by the dead bolt.

U.S. Pat. No. 4,890,870, issued on Jan. 2, 1990 by Miron, introduces a mortise lock with an automatic dead bolt, which is qualified as comprising an improved trigger. Basically, this system includes a latch hub for retracting the dead bolt and a latch bolt. A turn piece serves as a biasing mechanism for pushing the dead bolt into an extended position. A trigger bolt mechanism holds the dead bolt in a retracted position. Once a trigger bolt hits a strike plate on the door jamb when the door is closed, a cam link transmits a rotational movement to a dead bolt stop which moves substantially downward to release the biased dead bolt to its extended position.

U.S. Pat. No. 4,890,870 requires excessive force to manually retract the deadbolt and high door-closing forces to release the automatic dead bolt. The consequences of the requirement of such high force can include overstressing and breakage of the biasing mechanisms and the dead bolt tail piece. In this patent, the dead bolt stop, which holds the dead bolt retracted in the housing, is attached to the housing by a pivot point and is forced against the dead bolt by a spring. It is therefore a spring which acts against the dead bolt biasing mechanism, thus requiring the excessive force to release the dead bolt. Also, this may cause premature failure on the spring.

U.S. Pat. No. 5,820,177, issued on Oct. 13, 1998 by Moon, defines a mortise lock which provides a simpler mechanism. The assembly includes an automatic dead bolt in direct contact with a bolt retractor arm which applies inward pressure to the dead bolt in response to a bolt retractor hub rotation. This minimizes the amount of rotational force an operator must apply to the bolt retractor hub by a door handle to move the dead bolt from the dead bolt extended position to the dead bolt retracted position. The assembly also features a trigger bolt mechanism comprising a retracted dead bolt stop, for holding the dead bolt in a dead bolt retracted position, which only translates vertically about two stationary pins. In consequence thereof, the biasing forces are opposed by stationary pins. This feature simplifies the trigger bolt mechanism while making it more durable as a biasing mechanism is no longer needed to oppose to the dead bolt biasing forces. The assembly thus requires less force to release the dead bolt from the retracted position.

These two systems have limitations as they only offer an armed position for the dead bolt. The dead bolt is either in the extended position locking the door, or in the retracted position when the door is opened and armed for release upon the trigger bolt mechanism hitting the door strike. The mortise locks described above, when used as hotel door locks, require signs posted against the outside door handle to ask for privacy. This method is limited to indicatory purposes, as anybody with a key or card can enter the room, ignoring the privacy sign. The privacy sign may also have been removed by other hotel guests. In consequence thereof, it would be interesting to provide a room user with means for ensuring the privacy, by which he could selectively lock the door in a privacy or a normal mode. In the privacy mode, access would solely be granted to the room user and to hotel management in case of emergency. In the normal mode, the room would also be accessible to maintenance personnel.

It would be of interest to use the automatic dead bolt concept outside of hotel applications. Presently, systems involving dead bolts are retracted and extended manually by use of a key or the like. It would be an asset for a system to combine the automatic dead bolt release feature to a manual arming and disarming of the automatic dead bolt feature. In this way, the user could disarm the dead bolt from automatic release by the rotation of a thumb turn inside the door, and could reciprocally arm the automatic release of the dead bolt with the thumb turn before exiting the room. The user would consequently not need to throw the dead bolt by a key.

A further disadvantage of mortise locks with automatic dead bolt release systems resides in the fact that upon door closure there is a possibility that the dead bolt is not fully extended to the extended position. Furthermore, it can even remain in the retracted position due to a misalignment of the dead bolt with a dead bolt groove in the strike plate, the dead bolt groove being obstructed, or other reasons. In consequence thereof, the latch bolt ensures the locking of the door.

It would be of interest to overcome this problem by adding to the automatic dead bolt release system a latch bolt blocking system to ensure a safe locking of the latch bolt in case of an automatic dead bolt release failure.

### DISCLOSURE OF THE INVENTION

It is an aim of the present invention to provide a mortise lock assembly, especially but not exclusively for hotel door rooms, that can indicate and secure the privacy status of the room.

It is a further aim of the present invention to provide a mortise lock assembly, especially but not exclusively for commercial use, combining an automatic release of the dead bolt and a manual arming and disarming of the dead bolt.

It is still a further aim of the present invention to provide a mortise lock assembly combining an automatic release of the dead bolt and a latch bolt safety blocking mechanism.

### SUMMARY OF THE INVENTION

According to the above aims of the present invention, and according to a broad aspect thereof, there is provided a mortise lock assembly for mounting in a door opposite a strike plate on a door jamb. The mortise lock assembly has a lock housing with a dead bolt, reciprocally moveable between a dead bolt extended position, wherein the dead bolt extends substantially outward of the housing in an opening of the strike plate of the door jam, and a dead bolt retracted position, wherein the dead bolt is disposed inside the housing. A dead bolt biasing mechanism is provided in the housing and outwardly biases the dead bolt toward the dead bolt extended position. A bolt retractor mechanism moves the dead bolt to the dead bolt retracted position. A trigger bolt mechanism releasably engages the dead bolt in the dead bolt retracted position and automatically releases the dead bolt to the dead bolt extended position. A turn piece releasably locks the dead bolt in the dead bolt extended position. The turn piece comprises a hub, for connecting a thumb turn. The thumb turn rotates to a predetermined first or predetermined second position independently of the turn piece which co-acts with the dead bolt and which is displaced when the trigger bolt mechanism is actuated to release the dead bolt. The thumb turn also engages with the turn piece to move the dead bolt to the dead bolt retracted position.

According to a further broad aspect of the present invention and to a more specific embodiment thereof, the thumb turn comprises a positioning device allowing for an electronic or a magnetic recognition of the first or the second predetermined position.

According to a still further broad aspect of the present invention there is provided a mortise lock for mounting in a door opposite a strike plate on a door jamb. The mortise lock comprises a lock housing in which a dead bolt is moveable between (i) a dead bolt extended position, wherein the deadbolt extends substantially outward of the housing in an opening of the strike plate of the door jamb, (ii) a dead bolt armed retracted position, wherein the dead bolt is disposed inside the housing and armed for an automatic trigger bolt mechanism release of the dead bolt, and (iii) a dead bolt disarmed retracted position, wherein the dead bolt is disposed inside the housing and is disarmed from the automatic trigger bolt mechanism release of the deadbolt. A dead bolt biasing mechanism is provided in the housing and outwardly biases the dead bolt toward the dead bolt extended position. A bolt retractor mechanism moves the dead bolt to the dead bolt disarmed retracted position. A trigger bolt mechanism releasably engages the dead bolt in the dead bolt armed retracted position and automatically releases the dead bolt from the dead bolt armed retracted position to the dead bolt extended position. A turn piece automatically locks the dead bolt in the dead bolt extended position and for manually locks the dead bolt in the dead bolt disarmed retracted position. The turn piece has a hub, for connecting a thumb turn. The thumb turn engages the turn piece into or releases the turn piece from the dead bolt disarmed retracted position for arming or disarming the automatic trigger release of the bolt. A latch bolt is reciprocally moveable between a latch bolt extended position, wherein the latch bolt extends outward of the housing, and a latch bolt retracted position, wherein the latch bolt is disposed inside the housing.

According to a still further broad aspect of the present invention there is provided a mortise lock for mounting in a door opposite a strike plate on a door jamb. The mortise lock comprises a lock housing having a dead bolt, reciprocally moveable between a dead bolt extended position, wherein the dead bolt extends substantially outward of the housing in an opening of the strike plate of the door jamb, and a dead bolt retracted position, wherein the dead bolt is disposed inside the housing. A dead bolt biasing mechanism is provided in the housing and outwardly biases the dead bolt toward the dead bolt extended position. A bolt retractor mechanism moves the dead bolt to the dead bolt retracted position. A latch bolt is reciprocally moveable between a latch bolt extended position, wherein the latch bolt extends outward of the housing, and a latch bolt retracted position, wherein the latch bolt is disposed inside the housing. A trigger bolt mechanism releasably engages the dead bolt in the dead bolt retracted position, for automatically releasing the dead bolt to the dead bolt extended position. The trigger bolt mechanism comprises a trigger bolt, reciprocally moveable between a trigger bolt extended position, wherein the trigger bolt extends outward from the housing, and a trigger bolt retracted position, wherein the trigger bolt is disposed inside the housing. Means are provided for operative contact with a latch bolt arresting mean. The arresting means blocks the latch bolt in the latch bolt extended position when the trigger bolt is in the trigger bolt retracted position. A trigger biasing mechanism is provided in the housing and operatively biases the trigger arm toward the upper position. A turn piece locks the dead bolt in the dead bolt extended position, and comprises a turn piece cam 90 for releasing the dead bolt from the dead bolt extended position.

### BRIEF DESCRIPTION OF THE DRAWINGS

The invention will now be described in detail having reference to the accompanying drawings in which:

FIG. 1 is a partly sectioned side elevation view of an embodiment of the mortise lock assembly in accordance with the present invention;

FIG. 2 is a partly sectioned side elevation view of another embodiment of the mortise lock assembly in accordance with the present invention;

FIG. 3a is a fragmented view of a turn piece in a dead bolt retracted position;

FIG. 3b is a fragmented view of the turn piece locking a dead bolt in a dead bolt disarmed retracted position;

FIG. 3c is a fragmented view of the turn piece in a dead bolt armed retracted position

FIG. 4 is a plan view of the turn piece showing the hole adapted for the privacy function;

FIG. 5 is a view in perspective of the trigger arm; and

FIG. 6 is a view in perspective of a thumb turn and a spindle adapted for the privacy function.

### TECHNICAL DESCRIPTION

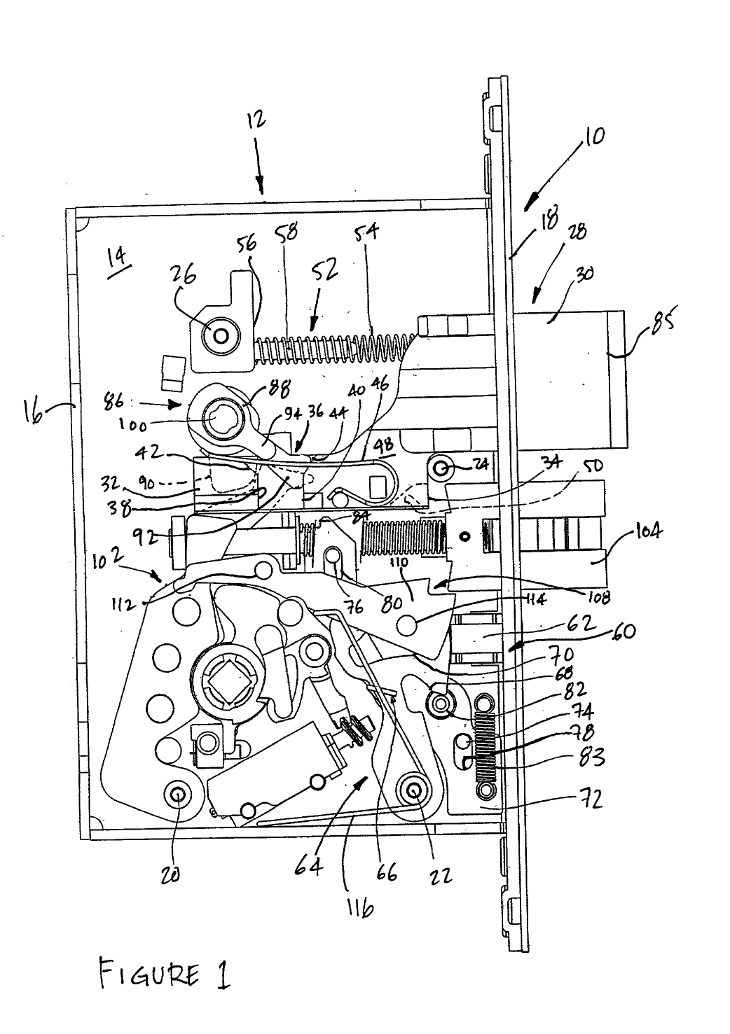

A mortise lock assembly for mounting in a door opposite a strike plate on a door jamb is generally shown at 10 in FIG. 1. The assembly comprises a housing 12, which consists in lateral walls 14, a back plate 16 and a front plate 18. The lateral walls 14 are spread apart by transverse posts 20, 22, 24, 26.

A dead bolt 28 is reciprocally moveable within the housing between a dead bolt extended position, shown in FIG. 1, and a dead bolt retracted position, shown in FIG. 2. A front portion 30 of the dead bolt 28 extends outside of the housing 12 in the dead bolt extended position as shown on FIG. 1, and is received in a notch disposed in the strike plate opposite the front plate 18 on the door jamb. The front portion 30 is disposed almost completely inside the housing in the dead bolt retracted position shown in FIG. 2. The dead bolt 28 further comprises a tail piece 32 rearwardly extending below the front portion 30. The tail piece 32 defines a square face 34 adjacent the front portion 30, and a slot 36, comprising lateral walls 38, 40 and beveled walls 42, 44. A leaf spring 46 is attached to a side wall 48 of the tail piece 32 and is located in the gap between the tail piece 32 and the lateral plate 14. The tail piece 32 also features a groove 50, adjacent the square face 34, on the bottom thereof.

The assembly 10 includes a dead bolt biasing mechanism 52. The dead bolt biasing mechanism 52 comprises a helical compression spring 54 that is mounted between the dead bolt 28 and an abutment 56 in the housing. The spring 54 surrounds a guide rod 58 extending forwardly from the abutment and serving as a guide for the spring 54. The spring 54 continuously biases the dead bolt 28 toward the dead bolt extended position.

The assembly 10 further comprises a trigger bolt mechanism 60. The trigger bolt mechanism 60 has a trigger bolt 62, reciprocally moveable between a trigger bolt extended position, wherein the trigger bolt extends outward from the housing as shown in FIG. 2, and a trigger bolt retracted position, wherein the trigger bolt is disposed inside the housing as shown in FIG. 1.

The trigger bolt 62 moves to the trigger bolt retracted position when hitting the strike plate. A trigger bolt lever 64, pivoting about the transverse post 22 and in operative contact with the trigger bolt 62, rotates counterclockwise in response to the inward motion of the trigger bolt 62. A helical spring 66 continuously biases the trigger bolt lever 64 in a clockwise direction. When the trigger bolt 62 is no longer restrained to the retracted position by the strike plate, the trigger bolt 62 is moved to the trigger bolt extended position by the operative contact with the trigger bolt lever 64, which is biased by the helical spring 66. The trigger bolt lever 64 also includes a trigger bolt lever cam 68 adjacent the trigger bolt 62, and a cam slot 70 at an end opposite the transverse post 22.

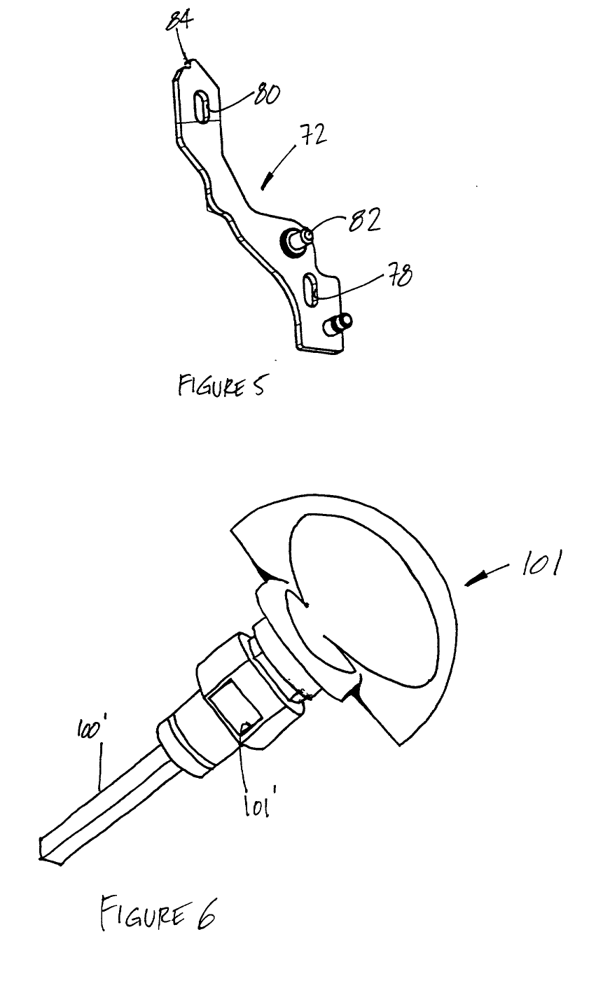

A trigger arm 72 translates upward to an upper position and downward to a lower position about guide pins 74, 76 by guide slots 78, 80, respectively. A helical extension spring 83 continuously biases the trigger arm in an upward direction. The trigger arm 72 further has a pin 82 adjacent the guide slot 78, and defines an abutment surface 84 at the opposite end of the trigger arm 72, as shown in FIG. 5.

The pin 82 is in operative contact with the trigger bolt lever cam 68 and therefore transmits rotations of the trigger bolt lever 64 to the trigger arm 72, which translates upward and downward in response to the trigger bolt lever 64.

When the trigger arm 72 is in the upper position, the abutment surface 84 is aligned with the square face 34 of the dead bolt 28. The dead bolt 28 is outwardly biased and abuts with the abutment surface 84, to be consequently releasably engaged in the dead bolt retracted position, as shown in FIG. 2.

When the trigger bolt 62 hits the strike plate, it moves inward to the trigger bolt retracted position. In response to the operative contact with the inwardly moving trigger bolt 62, the trigger bolt lever 64 rotates counterclockwise. The trigger bolt lever cam 68, rotating with the trigger bolt lever 64, pushes the pin 82, which drags the trigger arm 72 downward. The abutment surface 84 clears the square face 34 of the dead bolt 28, thereby releasing the dead bolt 28, which is biased to the dead bolt extended position, therefore engaging the dead bolt 28 into a groove in the strike plate.

If the gap between the door and the door jamb is relatively big (up to 5/16″), the dead bolt 28 may not retract far enough inwardly to engage in abutment with the trigger arm 72. The groove 50 of tail piece 32 will, however, engage in abutment with the abutment surface 84 of the trigger arm 72, to hold the dead bolt retracted generally inside the housing 12. In this case, the trigger arm 72 releases, as it would if the dead bolt 28 was fully retracted, the dead bolt 28 to the dead bolt extended position. Edges 85 of the front portion 30 of the dead bolt 28 are slightly rounded to ease the door closing.

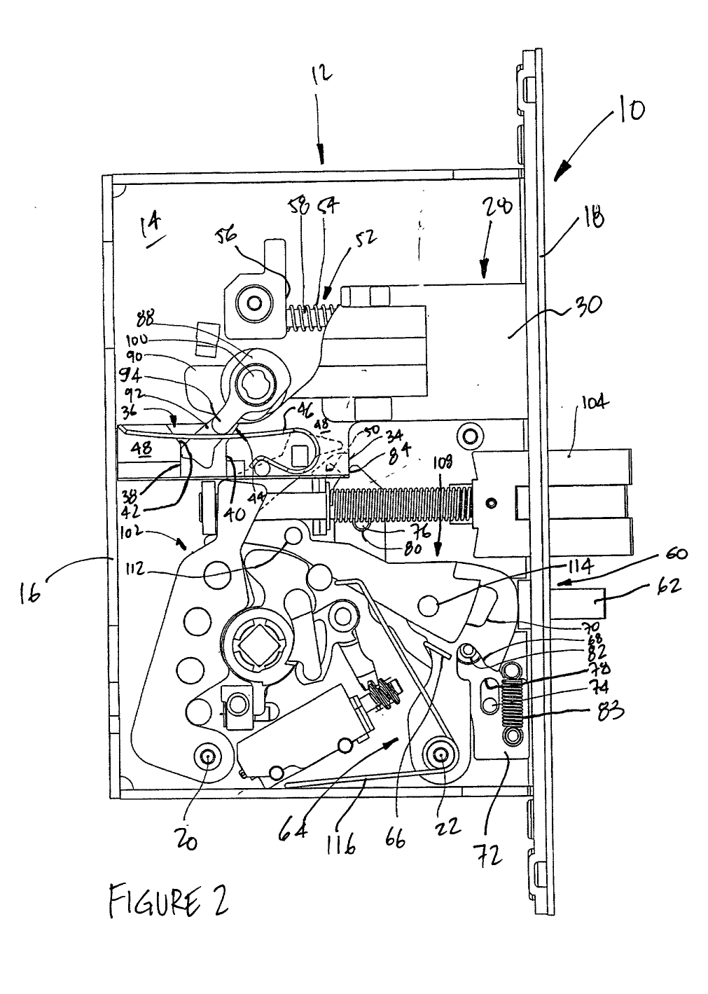

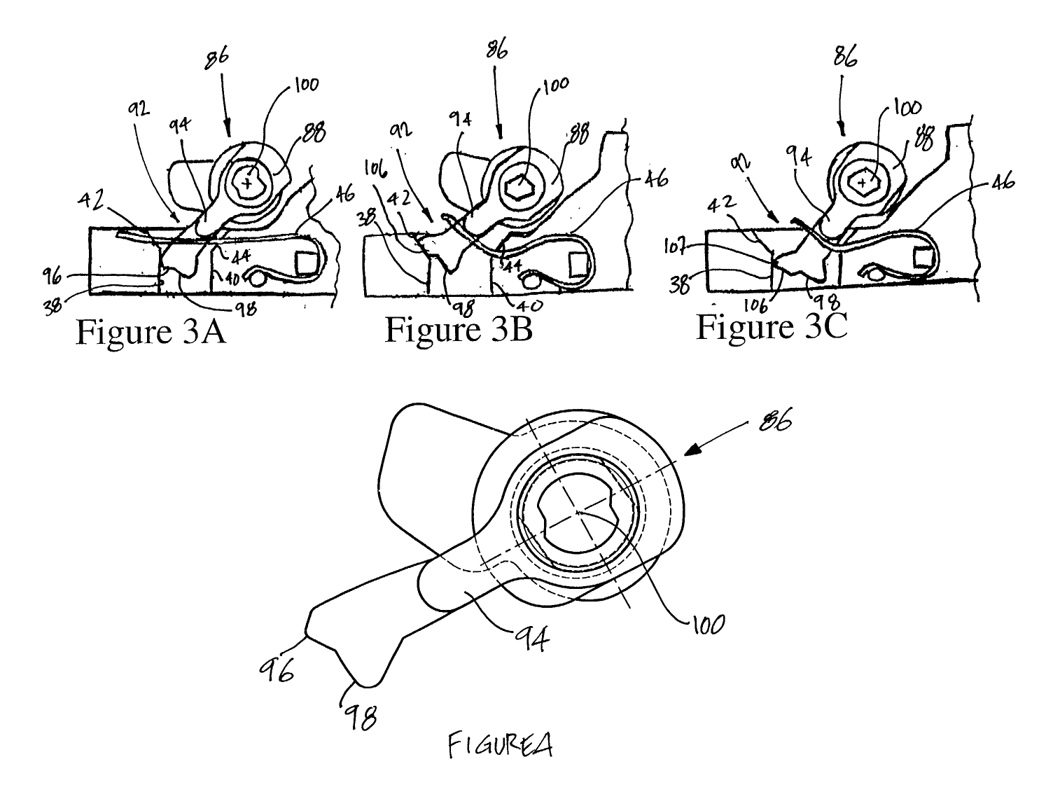

A turn piece 86 is included in the housing 12 and is located above the tail piece 32 of the dead bolt 28, as depicted more specifically in FIG. 3a. The turn piece 86 comprises a turn piece hub 88, a turn piece cam 90 and a turn piece arm 92. The turn piece cam 90 and the turn piece arm 92 extend from the turn piece hub 88 and rotate about the turn piece hub 88.

The turn piece arm 92 comprises a turn piece arm cam 94 protruding toward the lateral plate 14 of the housing 12. The turn piece arm cam 94 is in operative contact with the leaf spring 46 of the dead bolt 28. The leaf spring 46 serves for upwardly biasing the turn piece arm 92. The turn piece arm 92 defines at an end opposed to the turn piece hub 88 a cam surface 96 and a flat surface 98. When the dead bolt 28 is in the dead bolt extended position, the turn piece arm 92 abuts the lateral wall 40 and the beveled wall 44 of the slot 36 with the cam surface 96 and the flat surface 98, respectively. In consequence thereof, the dead bolt 28 is releasably locked in the dead bolt extended position. When the dead bolt 28 is in the dead bolt retracted position as shown of FIG. 2, the cam surface 96 rests on lateral wall 38 of the slot 36. The turn piece arm 92 and the dead bolt 28 co-act because of the operative contact between the turn piece arm 92 and the slot 36, and upon the automatic release of dead bolt 28 toward the dead bolt extended position, the turn piece arm 92 is displaced to lock the dead bolt 28 in the dead bolt extended position as described above.

The turn piece hub 88 comprises a hole 100 for receiving a spindle 100′, shown in FIGS. 4 and 6. The spindle is connected to a thumb turn 101. The shape of the hole 100, as shown in FIG. 4, allows the thumb turn 101 to rotate to a horizontal or a vertical position independently of the turn piece hub 88 and the turn piece arm 92. The shape of the hole 100 further allows the thumb turn 101 to maintain the horizontal or vertical position when the turn piece arm 92 rotates in response to the release of the dead bolt 28 toward the dead bolt extended position. Furthermore, when the thumb turn 101 is horizontal and the dead bolt is retracted from the dead bolt extended position, the turn piece will rotate the thumb turn 101 to the vertical position. On the other hand, the thumb turn 101 is fully independent of the turn piece hub 88 when it is vertical. However, with the dead bolt 28 in the dead bolt extended position, one can rotate the thumb turn 101, which will engage with the turn piece hub 88 to rotate the turn piece arm 92 clockwise. When doing so, because of the operative contact between the turn piece arm 92 and the dead bolt 28, the dead bolt 28 will move back to the dead bolt retracted position.

The turn piece cam 90 is in operative contact with a bolt retractor mechanism 102. A rotation of the bolt retractor mechanism 102 will rotate the turn piece cam 90, and consequently, the turn piece arm 92, to release the dead bolt 28 from the dead bolt extended position. When the dead bolt 28 reaches the dead bolt retracted position, the trigger arm 72 moves upward to block the dead bolt 28 as described above.

The mortise lock assembly 10 further comprises a latch bolt 104, reciprocally moveable between a latch bolt retracted position and a latch bolt extended position as shown in FIG. 1. The bolt retractor mechanism 102 is also in operative contact with the latch bolt 104 to inwardly move the latch bolt 104 to the latch bolt retracted position.

The free movement of the thumb turn 101 can provide an interesting feature to the mortise lock, as described hereinafter. The thumb turn 101 may include a positioning device in a housing 101′ as shown in FIG. 6, as a magnet or like, which allows for an electronic or a magnetic recognition of a pair of predetermined positions for the thumb turn 101 (i.e. the vertical and the horizontal position in the present embodiment). The predetermined positions are beforehand identified as a Privacy Mode position and a Normal Mode position. When the thumb turn is placed in the Privacy Mode position, room access is solely granted to the room user and to hotel management in case of emergency. In the Normal Mode, the room is also accessible to maintenance personnel. The position recognition provides a room user means to ensure his privacy.

A different embodiment of the mortise lock assembly is shown in FIGS. 3b and 3c, which depict modifications in the turn piece 86 from the previous embodiment (FIG. 3a). The hole 100 has a different shape, but still serves to hold a thumb turn through a spindle. This embodiment does not allow for an independent movement of the thumb turn in the hole 100. The thumb turn is integrally joined to the turn piece 86 and, in consequence thereof, any rotation of the turn piece arm 92 will cause an equal rotation of the thumb turn. The cam surface 96, adjacent the flat surface 98 on the turn piece arm 92 as shown in FIG. 3a, illustrating the previous embodiment, is replaced by a flat surface 106, substantially parallel to the flat surface 98 as shown in FIG. 3b. The flat surface 106 will abut with the beveled wall 42 of the slot 36 of the dead bolt 28, thereby locking the dead bolt 28 in the dead bolt retracted position, as shown in FIG. 3b. This locking is automatically obtained by retracting the dead bolt from the dead bolt extended position. In this position, hereinafter referred to as the dead bolt disarmed position, the dead bolt 28 will remain retracted at all times. However, the user can reciprocally arm the automatic release of the dead bolt by turning the thumb turn in a counterclockwise direction, in which case an edge 107 leans on the lateral wall 38 of the slot 36, because of the upward biasing provided by the leaf spring 46, as shown in FIG. 3c. In this position, the locking of the dead bolt 28 in the dead bolt disarmed retracted position is released. The system 10 is armed for the automatic release of the dead bolt 28 by the trigger bolt mechanism 60. Consequently, the user does not need to throw the dead bolt in the door jamb by a key.

Another embodiment of the present invention provides the mortise lock assembly with a safety mechanism for ensuring the locking of the door in case of a dead bolt 28 failure. If the dead bolt 28 remains in the retracted position due to a misalignment of the dead bolt with a dead bolt groove in the strike plate, if the dead bolt groove is obstructed, or for other reasons. In case of such a failure, the latch bolt 104 ensures the locking of the door. However, by the typical design of latch bolts, one can easily bypass this locking by the insertion of a flat device through the gap between the door and the door jamb and by applying pressure on the latch bolt to retract it inside the lock housing. The present embodiment surpasses this problem by providing a latch bolt arresting means 108, comprising a blocking lever 110 rotating about pivot 112. The latch bolt arresting means 108 further comprises at an end opposed to the pivot 112 a blocking lever pin 114, which is in operative contact with the cam slot 70 of the trigger bolt lever 64. When the door is closed, the trigger bolt 62 moves inward to the trigger bolt retracted position. A helical spring 116 rotates the blocking lever 110 counterclockwise in response to the operative contact between the cam slot 70 and the blocking lever pin 114. In doing so, the blocking lever 110 prevents the latch bolt 104 from inwardly moving to the latch bolt retracted position. Consequently, the latch bolt 104 is blocked into the latch bolt extended position when the trigger bolt 62 is in the trigger bolt retracted position. It is within the ambit of the present invention to provide any obvious modifications of the embodiments described herein, provided such modifications fall within the scope of the appended claims.

We claim:

1. A mortise lock assembly for mounting in a door opposite a strike plate in a door jamb and comprising:
a lock housing;
a dead bolt, reciprocally moveable between a dead bolt extended position, wherein said dead bolt extends substantially outward of said housing to enter in an opening of said strike plate of said door jamb, and a dead bolt retracted position, wherein said dead bolt is disposed inside said housing;
a dead bolt biasing mechanism, mounted within said housing and outwardly biasing said dead bolt toward said dead bolt extended position;
a bolt retractor mechanism, for moving said dead bolt to said dead bolt retracted position;
a trigger bolt mechanism, for releasably engaging said dead bolt in said dead bolt retracted position and for automatically releasing said dead bolt to said dead bolt extended position; and
a turn piece, for releasably locking said dead bolt in said dead bolt extended position, and comprising a hub, for connecting a thumb turn, said thumb turn (i) rotating to a predetermined first or predetermined second position independently of said turn piece which co-acts with said dead bolt, said turn piece being displaced when said trigger bolt mechanism is actuated to release said dead bolt, and (ii) also said thumb turn engaging with said turn piece to move said dead bolt to said dead bolt retracted position.

2. The mortise lock assembly as defined in claim 1 further comprising:
a latch bolt, reciprocally moveable between a latch bolt extended position, wherein said latch bolt extends outward of said housing, and a latch bolt retracted position, wherein said latch bolt is disposed inside said housing;
a latch bolt biasing mechanism, mounted within said housing and outwardly biasing said latch bolt toward said latch bolt extended position; and
said bolt retractor mechanism, operatively engageable with said latch bolt to displace said latch bolt to said latch bolt retracted position.

3. The mortise lock assembly as defined in claim 2, wherein said trigger bolt mechanism comprises:
a trigger bolt, reciprocally moveable between a trigger bolt extended position, wherein said trigger bolt extends outward from said housing, and a trigger bolt retracted position, wherein said trigger bolt is disposed inside said housing;
a trigger bolt lever, mounted within said housing and in operative contact with said trigger bolt, for biasing said trigger bolt into said trigger bolt extended position, and comprising a trigger bolt lever cam for moving a trigger arm in response to an inward motion of said trigger bolt;
said trigger arm, in operative contact with said trigger bolt lever cam and reciprocally moveable between an upper position, wherein said trigger arm is in abutting engagement with said dead bolt in said dead bolt retracted position, and a lower position, wherein said trigger arm moves downward in response to said trigger bolt lever cam to release said dead bolt from said dead bolt retracted position; and
a trigger arm biasing mechanism, mounted within said housing and upwardly biasing said trigger arm toward said upper position.

4. The mortise lock assembly as defined in claim 3, wherein said trigger bolt lever comprises a cam slot, for engaging an operative contact with a latch bolt arresting mechanism, said arresting mechanism blocking said latch bolt in said latch bolt extended position when said trigger bolt is in said trigger bolt retracted position.

5. The mortise lock assembly as defined in claim 1, wherein said dead bolt has a tail piece comprising a dead bolt slot defined by beveled walls and lateral walls for receiving in abutment a turn piece arm for releasably locking said dead bolt in said dead bolt extended position.

6. The mortise lock assembly as defined in claim 5, wherein said turn piece comprises:
said turn piece arm, in operative contact with said dead bolt and consequently moveable between said dead bolt extended position, wherein said turn piece arm releasably locks said dead bolt in abutting engagement with said dead bolt beveled and lateral walls, and said dead bolt retracted position, wherein said turn piece arm rests against said lateral wall of said dead bolt slot;
a turn piece arm biasing mechanism, mounted within said housing and continuously biasing said turn piece arm in an upward direction, wherein said turn piece arm is in abutment with said dead bolt in said dead bolt extended position or in said dead bolt retracted position;
said hub, having connection means for holding a thumb turn in said predetermined first or said predetermined second position, for (i) allowing said thumb turn to maintain said predetermined first or second position independently of a movement of said turn piece arm in response to said dead bolt when said trigger bolt mechanism releases said dead bolt, and for (ii) further allowing said thumb turn to engage with said turn piece arm to displace said dead bolt to said dead bolt retracted position; and
a turn piece cam, for engaging an operative connection with said bolt retractor mechanism.

7. The mortise lock assembly as defined in claim 6, wherein said thumb turn moves from said predetermined first position to said predetermined second position in response to said dead bolt when said dead bolt moves from said dead bolt extended position to said dead bolt retracted position.

8. The mortise lock assembly as defined in claim 7, wherein said turn piece arm defines, at an end opposed to said hub, a cam surface and a flat surface for abutting engagement with said beveled and said lateral walls of said dead bolt slot.

9. The mortise lock assembly as defined in claim 1, wherein said thumb turn comprises a positioning device allowing for an electronic or a magnetic recognition of said first or said second predetermined position.

10. A mortise lock assembly for mounting in a door opposite a strike plate in a door jamb and comprising: a lock housing;
a dead bolt, moveable between (i) a dead bolt extended position, wherein said dead bolt extends substantially outward of said housing in an opening of said strike plate of said door jamb, (ii) a dead bolt armed retracted position, wherein said dead bolt is disposed inside said housing and armed for an automatic trigger bolt mechanism release of said dead bolt, and (iii) a dead bolt disarmed retracted position, wherein said dead bolt is disposed inside said housing and is disarmed from said automatic trigger bolt mechanism release of said dead bolt;
a dead bolt biasing mechanism, mounted within said housing and outwardly biasing said dead bolt toward said dead bolt extended position;
a latch bolt, reciprocally moveable between a latch bolt extended position, wherein said latch bolt extends outward of said housing, and a latch bolt retracted position, wherein said latch bolt is disposed inside said housing.
a bolt retractor mechanism, for (i) moving said dead bolt to said dead bolt disarmed retracted position and for (ii) moving said latch bolt to said latch bolt retracted position;
a trigger bolt mechanism, for releasably engaging said dead bolt in said dead bolt armed retracted position and for automatically releasing said dead bolt from said dead bolt armed retracted position to said dead bolt extended position; and
a turn piece, for automatically locking said dead bolt in said dead bolt extended position and for locking said dead bolt in said dead bolt disarmed retracted position, and comprising a hub, for connecting a thumb turn, said thumb turn engaging said turn piece into or releasing said turn piece from said dead bolt armed retracted position for arming or disarming said automatic trigger release of said dead bolt.

11. The mortise lock assembly as defined in claim 10 further comprising a latch bolt biasing mechanism, mounted within said housing and outwardly biasing said latch bolt toward said latch bolt extended position.

12. The mortise lock assembly as defined in claim 10, wherein said trigger bolt mechanism has:
a trigger bolt, reciprocally moveable between a trigger bolt extended position, wherein said trigger bolt extends outward from said housing, and a trigger bolt retracted position, wherein said trigger bolt is disposed inside said housing;
a trigger bolt lever, mounted within said housing and in operative contact with said trigger bolt, for biasing said trigger bolt into said trigger bolt extended position, and comprising a trigger bolt lever cam for moving a trigger arm in response to an inward motion of said trigger bolt;
said trigger arm, in operative contact with said trigger bolt lever cam and reciprocally moveable between an upper position, wherein said trigger arm is in abutting engagement with said dead bolt in said dead bolt armed retracted position, and a lower position, wherein said trigger arm moves downward in response to said trigger bolt lever cam to release said dead bolt from said dead bolt armed retracted position; and
a trigger arm biasing mechanism, mounted within said housing and upwardly biasing said trigger arm toward said upper position.

13. The mortise lock assembly as defined in claim 12, wherein said trigger bolt lever has a cam slot, for engaging an operative contact with a latch bolt arresting mechanism, said arresting mechanism blocking said latch bolt in said latch bolt extended position when said trigger bolt is in said trigger bolt retracted position.

14. The mortise lock assembly as defined in claim 10, wherein said dead bolt has a tail piece comprising a dead bolt slot defined by beveled walls and lateral walls for receiving in abutment a turn piece arm for releasably locking said dead bolt in said dead bolt extended position and for locking said dead bolt in said dead bolt disarmed retracted position.

15. The mortise lock assembly as defined in claim 14, wherein said turn piece comprises:
said turn piece arm, in operative contact with said dead bolt and consequently moveable between (i) said dead bolt extended position, wherein said turn piece arm releasably locks said dead bolt in abutting engagement with said dead bolt beveled and lateral walls, (ii) said dead bolt armed retracted position, wherein said turn piece arm rests against said lateral wall of said dead bolt slot, and (iii) said dead bolt disarmed retracted position, wherein said turn piece arm locks said dead bolt in abutting engagement with said dead bolt beveled and lateral walls;
a turn piece arm biasing mechanism, mounted within said housing and upwardly biasing said turn piece arm in an upward direction toward either side of beveled and lateral walls of said dead bolt slot; and
said hub, comprising connection means for holding a thumb turn, said thumb turn engaging said turn piece arm into said dead bolt armed or disarmed retracted positions; and
a turn piece cam, for engaging an operative connection with said bolt retractor mechanism.

16. The mortise lock assembly as defined in claim 15, wherein said turn piece arm defines, at an end opposed to said hub, flat surfaces for abutting engagement with said beveled and said lateral walls of said dead bolt slot.

17. A mortise lock assembly for mounting in a door opposite a strike plate in a door jamb and comprising:
a lock housing;
a dead bolt, reciprocally moveable between a dead bolt extended position, wherein said dead bolt extends substantially outward of said housing in an opening of said strike plate of said door jamb, and a dead bolt retracted position, wherein said dead bolt is disposed inside said housing;
a dead bolt biasing mechanism, mounted within said housing and outwardly biasing said dead bolt toward said dead bolt extended position;
a latch bolt, reciprocally moveable between a latch bolt extended position, wherein said latch bolt extends outward of said housing, and a latch bolt retracted position, wherein said latch bolt is disposed inside said housing;
a bolt retractor mechanism, for (i) moving said dead bolt to said dead bolt retracted position and for (ii) moving said latch bolt to said latch bolt retracted position;
a trigger bolt mechanism, for releasably engaging said dead bolt in said dead bolt retracted position, for automatically releasing said dead bolt to said dead bolt extended position, and comprising (i) a trigger bolt, reciprocally moveable between a trigger bolt extended position, wherein said trigger bolt extends outward from said housing, and a trigger bolt retracted position, wherein said trigger bolt is disposed inside said housing, and (ii) a mechanism for operative contact with a latch bolt arresting mechanism, said arresting mechanism blocking said latch bolt in said latch bolt extended position when said trigger bolt is in said trigger bolt retracted position;
a trigger arm biasing mechanism, mounted within said housing, upwardly biasing said trigger arm toward said upper position; and
a turn piece, for locking said dead bolt in said dead bolt extended position, and comprising a thumb turn for releasing said dead bolt from said dead bolt extended position.

18. The mortise lock assembly as defined in claim 17, wherein the trigger bolt mechanism further comprises:
a trigger bolt lever, mounted within said housing and in operative contact with said trigger bolt, for biasing said trigger bolt into said trigger bolt extended position, and comprising (i) a trigger bolt lever cam for moving a trigger arm in response to an inward motion of said trigger bolt, and (ii) a cam slot, for engaging the operative contact with a latch bolt arresting mechanism; and
said trigger arm, in operative contact with said trigger bolt lever cam and reciprocally moveable between an upper position, wherein said trigger arm is in abutting engagement with said dead bolt in said dead bolt retracted position, and a lower position, wherein said trigger arm moves downward in response to said trigger bolt lever cam to release said dead bolt from said dead bolt retracted position.

19. The mortise lock assembly as defined in claim 17 further comprising a latch bolt biasing mechanism, mounted within said housing and outwardly biasing said latch bolt toward said latch bolt extended position.

20. The mortise lock assembly as defined in claim 17, wherein said dead bolt includes a tail piece comprising a dead bolt slot defined by beveled walls and lateral walls for receiving in abutment a turn piece arm for releasably locking said dead bolt in said dead bolt extended position.

21. The mortise lock assembly as defined in claim 20, wherein said turn piece comprises:
said turn piece arm, for releasably locking said dead bolt in abutting engagement with said dead bolt beveled and lateral walls;
a turn piece arm biasing mechanism, mounted within said housing and upwardly biasing said turn piece arm toward either side of beveled and lateral walls of said dead bolt slot;
said hub, having connection means for holding a thumb turn for releasing said dead bolt from said dead bolt extended position; and
a turn piece cam, for engaging an operative connection with said bolt retractor mechanism.

22. The mortise lock assembly as defined in claim 21, wherein said thumb turn rotates to a first predetermined or a second predetermined position independently of said turn piece which co-acts with said dead bolt and which is displaced when said trigger bolt mechanism is actuated to release said dead bolt, and also engages with said turn piece to move said dead bolt to said dead bolt retracted position.

23. The mortise lock assembly as defined in claim 22, wherein said thumb turn moves from said predetermined first position to said predetermined second position in response to said dead bolt when said dead bolt moves from said dead bolt extended position to said dead bolt retracted position.

24. The mortise lock assembly as defined in claim 23, wherein said thumb turn comprises a positioning device allowing for an electronic or a magnetic recognition of said first or said second predetermined position.

25. The mortise lock assembly as defined in claim 21, wherein said turn piece comprises an abutment surface for releasably locking said dead bolt in a dead bolt disarmed retracted position, wherein said dead bolt is disposed inside said housing and is disarmed from said automatic trigger bolt mechanism release of said dead bolt.
